(19) United States
(12) Patent Application Publication
(10) Pub. No.: US 2013/0112087 A1
(43) Pub. Date: May 9, 2013

(54) ROASTING PAN

(71) Applicant: JOHN R HASSELL, Tampa, FL (US)

(72) Inventor: JOHN R HASSELL, Tampa, FL (US)

(21) Appl. No.: 13/292,454

(22) Filed: Nov. 9, 2011

(51) Int. Cl. A47J 37/04

(52) U.S. Cl. 99/421 H

(57) ABSTRACT

A roasting pan is disclosed. The roasting pan may include a dual skewered system providing a stable mounting preventing pivoting and rotating of a mounted subject. The roasting pan may also include raised end walls providing a gap between the bottom surface of the subject and a base wall of the pan. The roasting pan may also include a lower profile side wall providing increased airflow to the sides, ends, and bottom of the subject.

### BACKGROUND OF THE INVENTION

The present invention generally relates to cooking equipment, and more particularly, to a roasting pan.

Roasting game and fowl conventionally includes skewering the subject onto a single skewer between ends of a roasting pan. The mounted subject, for example chicken, may be held in place by friction of the chicken mass on the skewer. However larger game or fowl, for example turkeys, may not fit well into conventional roasting pans. Turkeys, for example, may be particularly heavier than contemplated for conventional skewer mounting. A turkey may be subject to rotating about a single skewer because of the distribution of mass may be biased toward one side more than another. The heavier side of a turkey may tend to face the bottom surface of a roasting pan, often in contact with the pan. During cooking, contact with the heated pan may deform and scorch the bottom facing surface of the turkey. Thus, while the bottom surface may receive direct conductive heating, the top surface of the turkey may receive cooler convection heating, while the sides and ends may be obstructed from receiving direct airflow receiving yet cooler heating than the top and bottom.

As can be seen, there is a need for an apparatus that provides stabilization to a mounted subject in a roasting pan. It can also be seen that there is a need to provide uniform heating to a subject mounted in a roasting pan.

### SUMMARY OF THE INVENTION

In one aspect of the present invention, a roasting pan comprises a base wall; a plurality of sidewalls projecting up from the base wall; a skewer mount on at least two opposing ends of the sidewalls; and a dual skewer system including a pair of juxtaposed skewers that serve to stabilize the naturally preferred orientation of a skewered turkey, the pair of skewers adapted to attach to the skewer mount.

In another aspect of the present invention, a roasting pan comprises a base wall; side walls projecting up from the base wall the sidewalls including a pair of opposing linear top edges and at least one depressed edge portion that is lower than the top edges; a skewer mount on each of the opposing top edges; and a skewer system mountable between the skewer mounts.

In still yet another aspect of the present invention, a roasting pan comprises a base wall; two side walls projecting up from the base wall at a first height; two raised end walls projecting up from the base wall at a second height wherein the second height is greater than the first height; a skewer mount on each of the raised end walls; and a skewer system mountable between the skewer mounts.

These and other features, aspects and advantages of the present invention will become better understood with reference to the following drawings, description and claims.

### BRIEF DESCRIPTION OF THE DRAWINGS

FIG. 1 is a perspective side view of a roasting pan holding a turkey in accordance with an exemplary embodiment of the present invention;

FIG. 2 is an exploded view of the roasting pan of FIG. 1;

FIG. 3 is a partial exploded end view of a skewer mount employed in the roasting pan of FIG. 1 in accordance with an exemplary embodiment of the present invention;

FIG. 4 is a broken perspective end view of an end wall and skewer mount of the roasting pan of FIG. 1; and

FIG. 5 is a cross-sectional side view of the roasting pan of FIG. 1 taken along the line 5-5 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims. Various inventive features are described below that can each be used independently of one another or in combination with other features.

Broadly, embodiments of the present invention generally provide a roasting pan configured to provide improved roasting to larger and heavier cooking subjects. For example, conventional roasting pans may be suitable for cooking subjects such as small game and fowl such as chickens. However, larger game, for example, turkeys may be subject to turning, burning, and uneven cooking on conventional roasting and rotisserie pan systems. Aspects of the roasting pan disclosed may prevent undesirable turning of a cooking subject while providing improved heated air circulation round the subject.

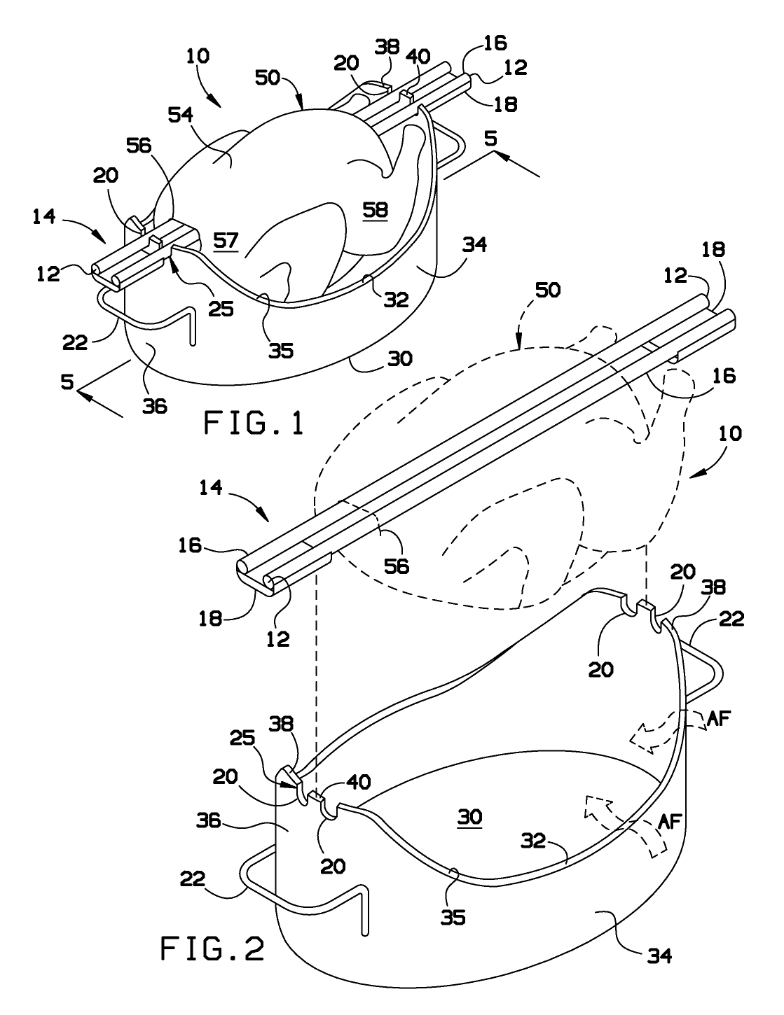

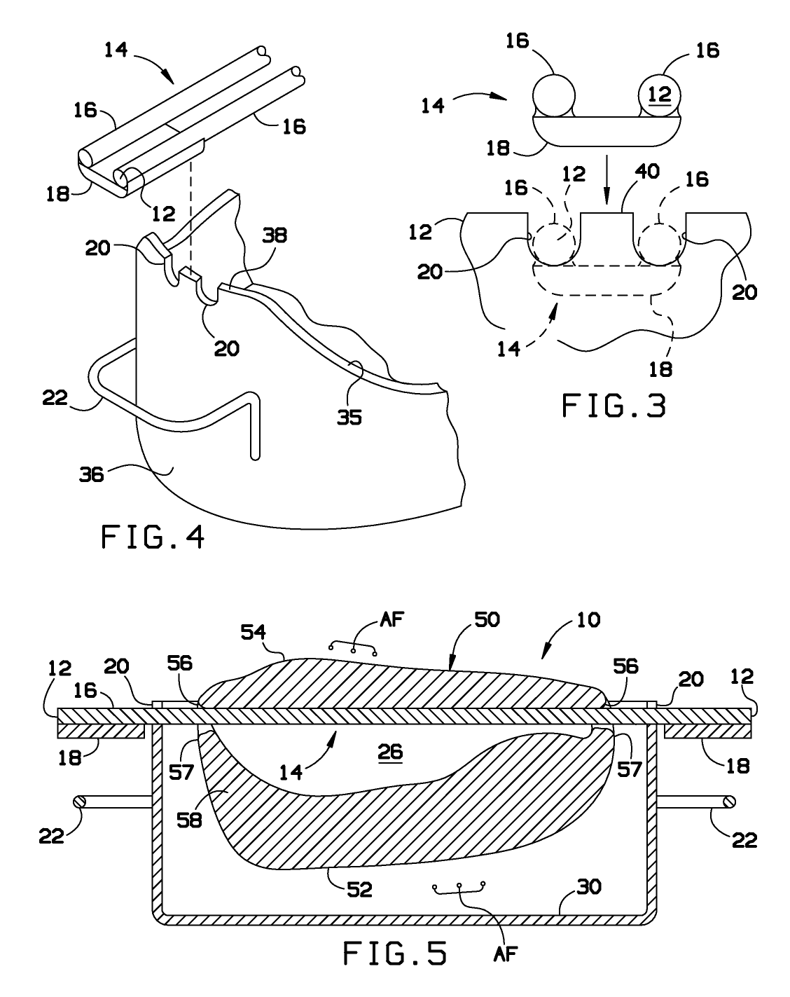

Referring to FIGS. 1-5, a roasting pan 10 may include a base wall 30, a plurality of side walls 34 and 36 projecting up from the base wall 30, a skewer mount 25, and a dual skewer system 14. The roasting pan 10 may be constructed from sturdy, heat resistant material such as metal known in the art suitable to withstand cooking and in particular, roasting. The roasting pan 10 may be configured to support a mounted cooking subject 50 that is typically larger than for example, a chicken. For sake of illustration, a turkey is shown to represent the mounted subject 50 however it will be understood that other animals may be cooked and benefit from aspects of the roasting pan 10.

End side walls 36, (also referred to as end walls 36) may be raised above the side walls 34, configured to detain the skewer system 14 in a position to hold a bottom surface 52 of the mounted subject 50 raised above the base wall 30. The end walls 36 may include a top edge 38 at a height above the base wall 30. The end walls 36 include a skewer mount 25. The skewer mount 25 may include a pair of slots 20 depressed into the top edge 38 adapted to receive the skewers 16. The skewer mount 25 may also include a detent 40 between the slots 20 separating the skewers 16 from one another while the skewer system 14 is resting on the mount 25. A pair of pan handles 22 may be attached to the end walls 36, however it will be understood that the pan handles 22 may be attached to any of the side walls 34 or 36.

In one aspect, the side walls 34 may be configured to expose a majority of the sides 58 of the mounted subject 50 below the top edges 38. The side walls 34 may include a depressed edge 32 positioned at a height below the top edge 38. The depressed edge 32 may be substantially curvilinear. A tapering edge 35 may taper down from the top edge 38 down to the depressed edge 32 providing a lower profile along the side walls 34 than the end walls 36.

The dual skewer system 14 may include a pair of skewers 16. The skewers 16 may be attached proximate their ends 12 to skewer handles 18 so that the skewers 16 are juxtaposed, spaced apart from one another. The end walls 36 may include a skewer mount 25 configured to hold the skewers 16 to extend between opposing end walls 36 parallel from one another. The skewer handles 18 may be positioned on the outside of the detents 40.

In one exemplary use, a turkey 50 may be skewered through an insertion point 56, through a body cavity 26, and out an opposing insertion point 56 so that the skewer ends 12 may be set into the slots 20. In FIGS. 1, 2 and 5, the turkey 50 is shown breast side down. The spaced dual skewers 16 may work together to provide a strengthened support and to stabilize the turkey 50, preventing it from pivoting or rotating around in the roasting pan 10. The detent 40 may also work in conjunction with the skewer handle 18 to obstruct the skewers 16 from sliding axially along the length of the roasting pan 10. The skewer handles 18 may provide a wide, stable grip for setting the turkey 50 onto and lifting from the roasting pan 10.

When set on to the roasting pan 10, a bottom surface 52 of the turkey 50, may be subject to heated air flow AF. The raised end walls 36 may create a gap between the turkey bottom surface 52 and the base wall 30 preventing contact with the heated bottom wall 30. The heated air flow AF may flow both over an exposed top surface 54 of the turkey 50 and over depressed edges 32. When flowing over the depressed edge 32, the airflow AF may travel under the bottom surface 52 and out over the opposing depressed edge 32. Heated airflow AF may also travel over the tapered edges 35 thus making contact with turkey ends 57. Thus the turkey 50 may be provided with substantially even heating around the top surface 54, sides 58, ends 57, and the bottom surface 52.

It should be understood, of course, that the foregoing relates to exemplary embodiments of the invention and that modifications may be made without departing from the spirit and scope of the invention as set forth in the following claims.

What is claimed is:

1. A roasting pan, comprising:
a base wall;
a plurality of sidewalls projecting up from the base wall;
a skewer mount on at least two opposing ends of the sidewalls; and
a dual skewer system including a pair of juxtaposed skewers, the pair of skewers adapted to attach to the skewer mount.

2. The roasting pan of claim 1, further comprising a handle attached to the skewer ends, wherein the handle connects one of the pair of skewers to the other of the pair of skewers.

3. The roasting pan of claim 2 wherein the pair of skewers are spaced apart.

4. The roasting pan of claim 1 wherein the opposing ends of the side walls include pairs of slots adapted to receive each of the skewers.

5. A roasting pan, comprising:
a base wall;
side walls projecting up from the base wall the sidewalls including a pair of opposing linear top edges and at least one depressed edge portion that is lower than the top edges;
a skewer mount on each of the opposing top edges; and
a skewer system mountable between the skewer mounts.

6. The roasting pan of claim 5, further comprising a tapered edge portion between the top edges and the depressed edge portion.

7. The roasting pan of claim 5 wherein the depressed edge portion is configured to expose sides of a subject mounted onto the skewer system, wherein a majority of the sides of the mounted subject are positioned below the top edges.

8. A roasting pan, comprising:
a base wall;
two side walls projecting up from the base wall at a first height;
two raised end walls projecting up from the base wall at a second height wherein the second height is greater than the first height;
a skewer mount on each of the raised end walls; and
a skewer system mountable between the skewer mounts.

9. The roasting pan of claim 8 further wherein the raised end walls are positioned to hold a bottom surface of a mounted subject raised above the base wall.
